(19) United States
(12) Patent Application Publication
(10) Pub. No.: US 2008/0216056 A1
(43) Pub. Date: Sep. 4, 2008

(54) Fully integrated software change request system which includes but not limited to the following modules: change request, migration request, work flow engine project, collaboration, code movement, document tracking, code execution, status notification and database schema snapshot as well as various reporting capabilities.

(76) Inventors: Stephen Bate, Fitchburg, MA (US); Punniaraj Thambusamy, Falls Church, VA (US)

Correspondence Address: STEPHEN BATE, 3 MACINTOSH LANE, FITCHBURG, MA, 01420, US

(21) Appl. No.: 11/714,211

(22) Filed: Mar. 1, 2007

(51) Int. Cl. G06F 9/44

(52) U.S. Cl. 717/127

(57) ABSTRACT

A fully integrated Information Technology Software Development Life Cycle (SDLC) request management system comprising of a centralized database and a web interface which includes but not limited to the following modules: Change Request, Migration Request, Work Flow Engine, Project, Collaboration, Code Movement, Document Tracking, Code Execution, Status Notification and Database Schema Snapshot as well as various reporting capabilities are disclosed.

The SDLC request management system is installed on a server and accessed by a plurality of users over a communication network. A request to work on a piece of software is entered by a user in the change request module. Based on the predefined setting of a default workflow, the workflow engine will route the request to the appropriate personnel. Whether or not it is determined that the request requires a change in a piece of software, a notification will be made on the system and, the collaboration module will send out emails to all involved in this request. If it is determined that work needs to be done on a piece of software then, a project will be opened for the request and the workflow engine controls the life cycle. The developed code is moved to the various environments by the code movement module and the code execution, executes the code in any environment. Project documents, databases schema and execution return status are also captured in the system.

### FIELD OF INVENTION

The disclosed invention relates to a system and method for managing information technology request through the Information Technology Software Development Life Cycle. It includes techniques to open, assign, collaborate and close a software work request as well as, move, execute code in different platforms, track efforts and documents, migrate request and capture database schema.

### BACKGROUND

Most software development departments routinely receive request from the software users to fix defects in a piece of software or to develop new software. In either case, the department will somehow manage the process of opening the request through development, testing the software, collaboration with all requests participants, code movement and execution can be challenging and is often performed as individual isolated task using different systems or, performed manually. It becomes even more daunting when the work request participants are geographically dispersed and, collaboration at the various stages of the request is required.

A database server, as proposed in this invention can be used to track all activities relating to the opened request. For example, in typical software development department, multiple requests are opened of varying magnitudes. The request may range from no issue in the software and, requires only analysis to a, request for a new project. In each case, a team needs to be assembled to work on the request and collaboration amongst team members as well as priorities at each state is essential. In addition to the aforementioned, tracking of project documents, code migration, versions and movement can be a real challenge and confusing that requires more than manual isolated systems, as it is, in most departments today. This invention will render the manual process obsolete and if implemented, will achieve excellence and increased productivity.

### SUMMARY OF THE INVENTION

The present invention discloses a centralized database system that can be accessible throughout a communication network. A change request is opened for an issue in an existing software or for a new development. The issue is routed to the appropriate team members via a pre-defined workflow. Collaboration amongst team members, tracking of issues, code immigration across environments, platforms and code execution are some of the core functionalities disclosed in this invention. In a preferred embodiment, the database will include but not limited to the following field to support the functionality:

Reported User, Severity, Change Type, Priority, Impacted Projects, Reported Version, Scheduled Release, Owner, Current State, Efforts spent, Expected Completed Date and Actual Completed Date.

Customizable fields, search queries and search inquiries are included but not limited to search in change request, project, migration request and workflow. Associated reports include but not limited to

Request for Change, Change Request Detail Report, Change Request Report, Change Request Aging Report, Project Efforts, Milestone Report, Resource Utilization Report, Time Sheet Report, Staff/Personnel Planning Reports, Change Request Log, Migration Request Log, Project Risk Assessment Report, Costing Report by project stage/phase, Project Status Report and Release Notes, in one embodiment.

### BRIEF DESCRIPTION OF THE DRAWINGS

FIG. 1. Communication network system to implement the change control system.

FIG. 2. Workflow of the change request system.

FIG. 3. User interface to open a change request.

FIG. 4. Change request screen 2—Used to enter additional change request information.

FIG. 5. Project screen for entering project information.

FIG. 6. Migration request screen for entering migration request information.

FIG. 8. Migration job status for scheduling job to be executed by the script engine.

FIG. 9. Screen to enter code promotion information.

FIG. 10. Screen to run jobs by the scripts engine.

### DETAILED DESCRIPTION OF THE INVENTION

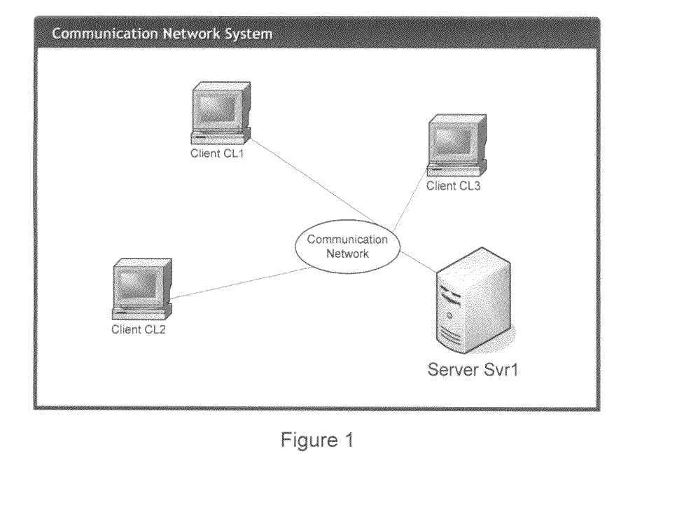

The invention can be implemented on a communication network comprising of but not limited to a server, data communications devices not shown (because, the art is well documented in the field of network) and client computers as depicted in the exemplary network system depicted in FIG. 1. In the server computer Svr1, a Server software such as Microsoft Windows 2000 and a database server such as Microsoft sql server are installed. By means of using the communication network, the client computers CL1, CL2, CL3 communicates with the server Svr1. In a preferred embodiment, where the communication protocol is HTTP, an HTTP server such as IIS is installed on the server Svr1 and web browser are installed on the client computers CL1, CL2 and CL3.

### Software Change Request

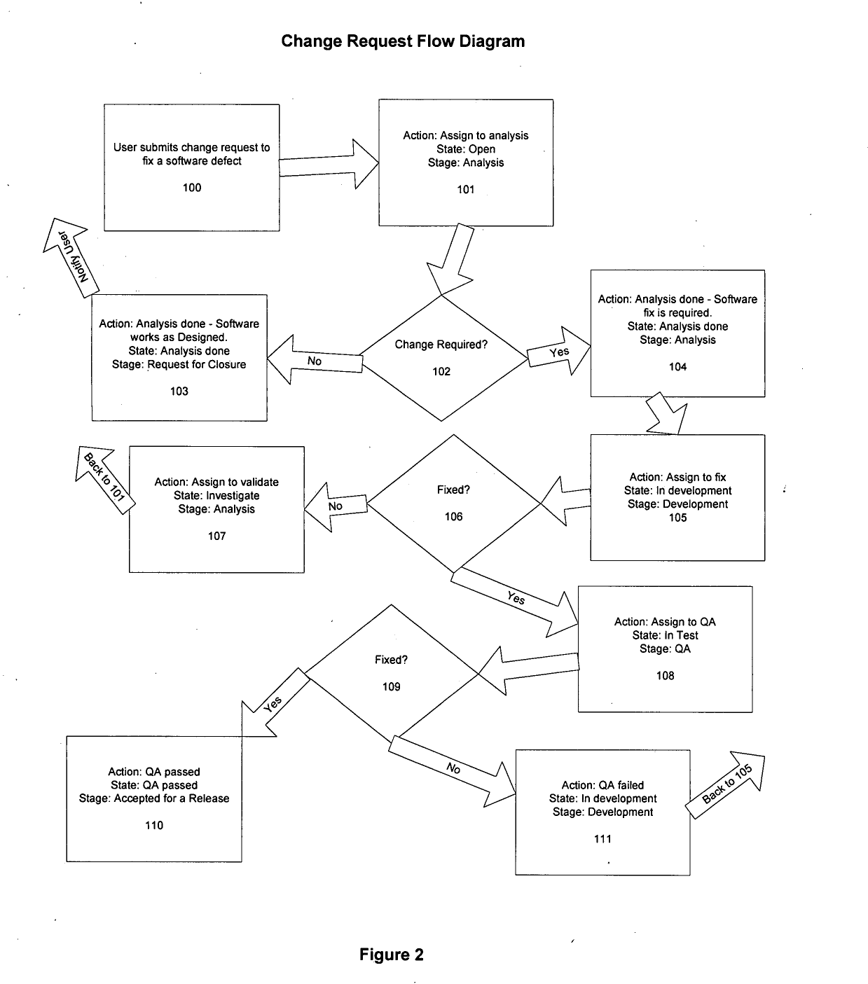

A workflow of a change request system in one embodiment of this invention is depicted in FIG. 2.

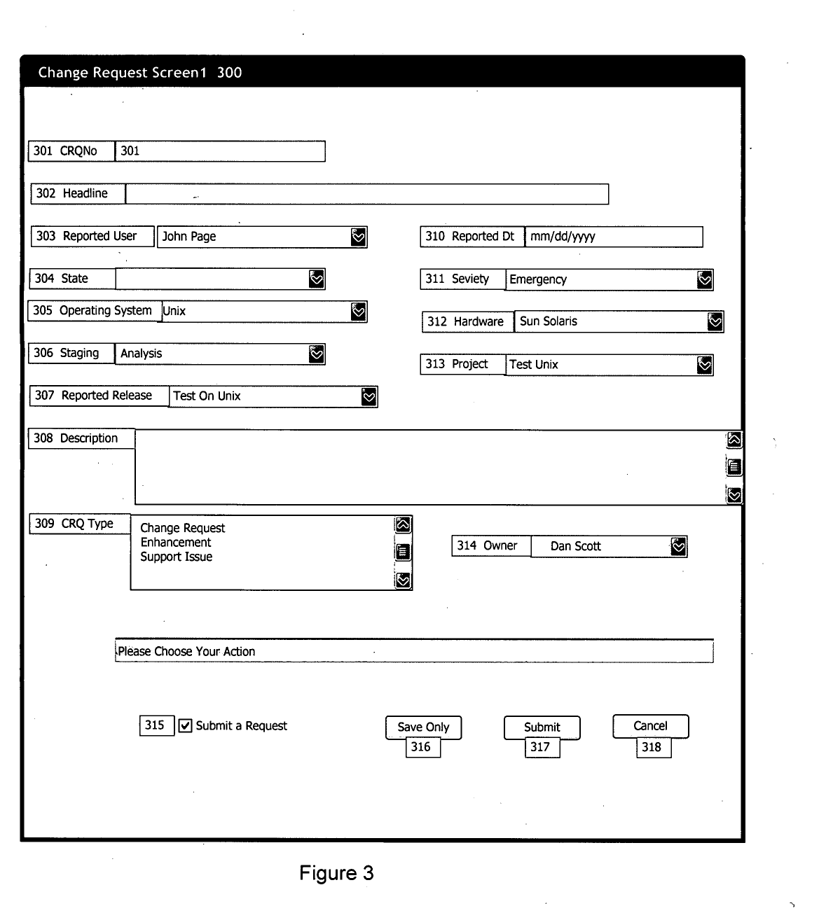

At the preliminary step 100, a request is submitted by a user for a change in an existing software (or for a new software to be developed) by generating a ticket using FIG. 3 Graphical User Interface (GUI). As a result of a predefined set up of the workflow, the action is changed to assign to analysis, 101 with a state of open and stage of Analysis. At this step 101, the change request ticket in assigned to a team member based on the predefined workflow. At step 102, a determination is made whether a change is needed or not. If no change is required, the action analysis done—software works as designed, 103 will be selected by the team member who did the analysis. Based on this action, accordingly, the state of analysis done and stage Request for closure is also assigned. However, if a problem is found in the software, then, the action of, analysis done—software fix needed 104, state of analysis done and stage of analysis, is assigned. In order for the software to be fixed, the action is subsequently changed to assign to fix 105, state, In development and stage of development.

In step 106, if the software is not fixed, the workflow is changed to step 107 and subsequently back to step 101, 102, etc. If the software is fixed, the code will be promoted to Quality Assurance (QA) for testing, step 108. where action is assigned to QA, State of In test and stage of QA.

If the software failed in Step 109, then the action is QA failed step 111, state: In development and stage development and subsequently goes back to step 105. If the software passed QA, the action is changed to QA passed 110, state QA passed and stage: Acceptance/awaiting release to production.

In an exemplary change request system in this invention, the graphical user interface (GUI) is developed using Active server pages (ASP). Other variations of the GUI in the invention can be developed using other dynamic webpage technologies such Java Server Pages (jsp).

Screen 300 depicted in FIG. 3 are exemplary elements involved when a user is opening a new change request. Note that the screens and data elements in this invention are not limited to screen 300 or data elements depicted in FIG. 3. In one embodiment, every opened change request is assigned a system generated number 301 by the change request software. The number increments by 1 and is used to track the request in the system. Another system generated data elements is reported date, 310 which is set to the date in which the request is opened. The description 308 is used by the requester to enter details of the description on the issue while, the subject of the request is entered in the Headline, 302. In this exemplary change request system, the screen 300 in FIG. 3 has a number of static dropdown windows (ddw) which includes 305, 307, 309, 311, 312 and 313. These ddw are static because they display what has been entered in the database tables and does not change depending on the state, stage or action of the request. 305 displays all the operating systems (eg. Unix) that the requester can be associated with. Reported Release 307, request type 309, severity of the request 311, the hardware used 312 and the project 313.

Sample values of 305 are Unix, Windows, Linux; 309, change request. Enhancement, support issue, research. For 311, emergency weekly release, standard release. 312, Sun Solaris, IBM and Dell. Naming conventions for all reported release, 307 and project, 313 can be defined and saved in the database and accessed by a user in the ddw. It is important to note that every new opened change request is assign to a designated default project and the user has the option of creating a new project and assigned to this request if it is deemed necessary. The reason being, the project module is used as a means to use the workflow module and also email notifications. Reported user, 303 displays the name of user who reported the issue.

At the time of opening the change request, the owner, 314 is used to select who owns the issue. Both reported user, 303 and owner have rights to close the change request or can delegate authority for closure of any change request with their names in these two fields.

Values in state, (304), staging (306) and action 315 are based on predefined workflow hence the data in these ddw are dynamic. Sample value for 304 is draft, 306 is analysis and 315 is submit a request.

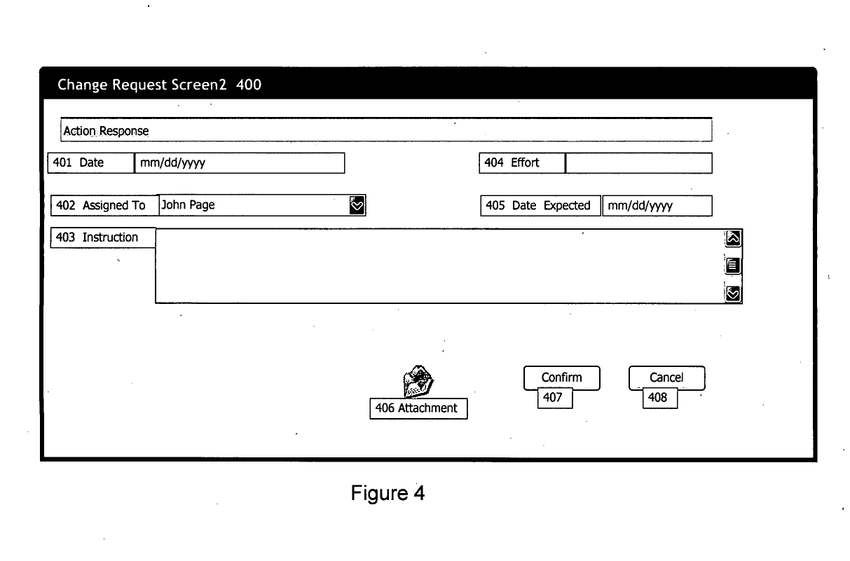

The user at the time of opening the change request has the option of only saving (316) to be submitted later, submit 317, or cancel, 318 the request. If the radio button (315) is checked and the request is submitted by clicking the button 317, the action response screen 400, FIG. 4 will display. Information on this screen 400 can be entered at the time of opening the change request or at a later time provided the user has authority to enter the information. For example, if a single user opens and assigns the request to a given individual then, screen 300 and 400 will be completed by that user. However, if users1 opens the request and some other designated user2 assigns the request, then user1 will not fill out screen 400 but, will click the button 407 to confirm the opened request. User2 will then at anytime enter the effort level, 404, expected date 405, who the request is assigned to 402 or any instructions, 403. Based on the workflow assigned to the project in FIG. 3, screen 300, 313, the assigned to ddw 402 will be pre-filled with the name of the person who will work on this request depending on the staging in screen 300, 306. However, the name in 402 can be changed.

The date, 401 is pre-filled with the current date. 406 is used for any attachment associated with this request and the cancel button 408 can be used to cancel and go back to screen 300.

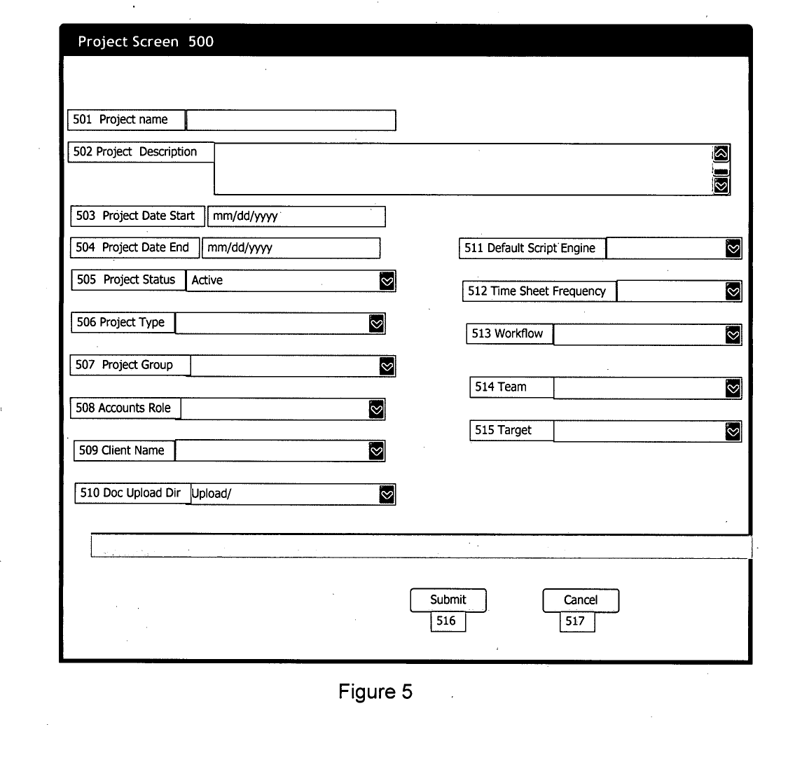

In a classic situation where it has been determined that indeed there is a defect in the software, a project will be opened using screen 500, FIG. 5 for a fix to be executed by the development team.

Project name, 501 can be associated with the opened change request screen 300, FIG. 3 by replacing the default project name in 313 with the project name in 501. The fields in FIG. 5 are exemplary and are representative of a preferred embodiment. The software change request system described in this invention may have a varied number of fields. Project description, project start and end dates are entered in field 502, 503, and 504 respectively. Static dropdown windows are provided for project status 505, project type 506, project group 507, Team Members's Role 508, client name 509, default script engine 511, time sheet frequency 512, workflow 513, team 514 and Source Code Targets 515. The Doc upload dir, 510 specifies the documentation repository for the project and the associated change request. Similarly, the target, 515 specifies the target environment in development, Quality Assurance (QA), production, etc. The workflow used for this project and team members are defined in 513 and 514 respectively. The default script engine field, 511 can be used to select the script engine to execute scripts for a given project. The button 516 is used to submit the project information to the database and cancel 517, to loose the data.

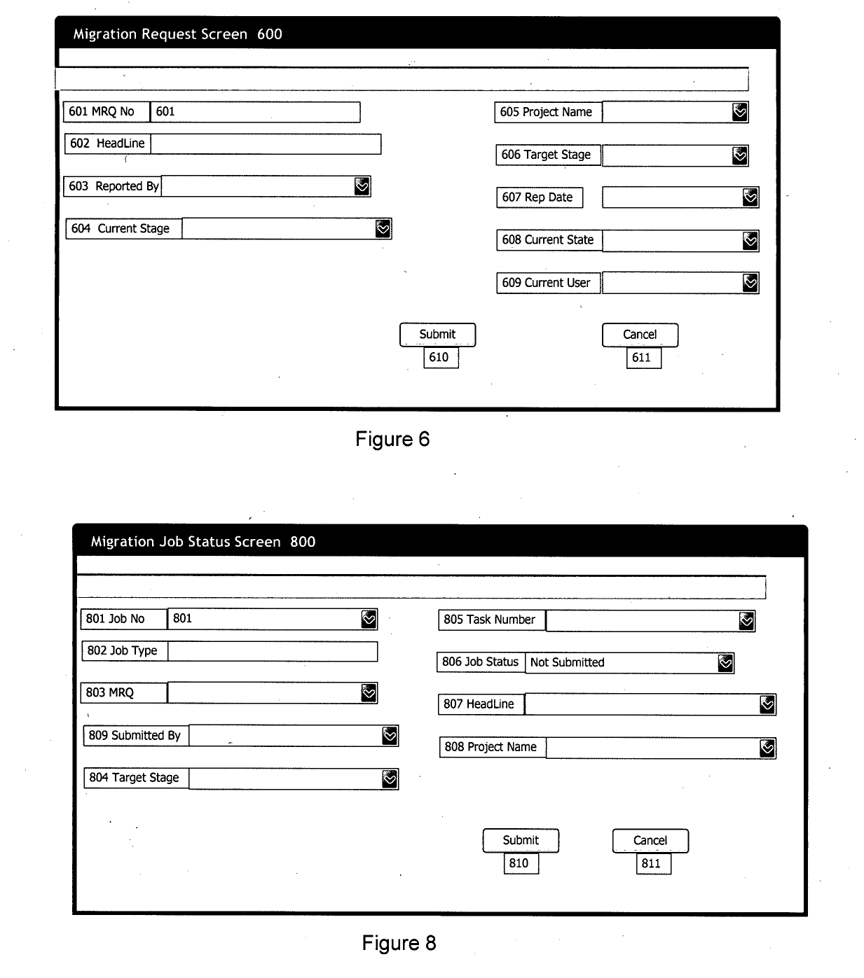

A typical process in a software shop is that, when the code is developed, it needs to be migrated to QA for testing and subsequently to production. The migration screen 600, FIG. 6 depicts database fields that are entered during a new migration opening episode.

In a preferred embodiment, if the project to be migrated is selected from the ddw, 605, the system checks to make sure that the project state is marked fixed for the given environment in development, QA or production, etc. However, with the authorization from a manager in the project team, this rule could be waived and the migration request module will work independent of the project status. The migration request number 601 is auto generated by the system at the time of opening the request. Headline, 602 is where the user enters the migration request subject. Based on the selected project in 605, the reported date, 607, current state, 608, issue reported by, 603, Current user 609 and current stage 604 are auto populated. The target stage, 606 is selected in the ddw and is used to signify the intended migration stage. The migration request screen can use the same workflow as the change request and project but can also work independently using a different workflow name. To complete the migration request and in turn execution of the code using the script engine, the code promotion and migration job status screens needs to be completed. The submit 610 and Cancel button 611 are used to submit the request or cancel respectively.

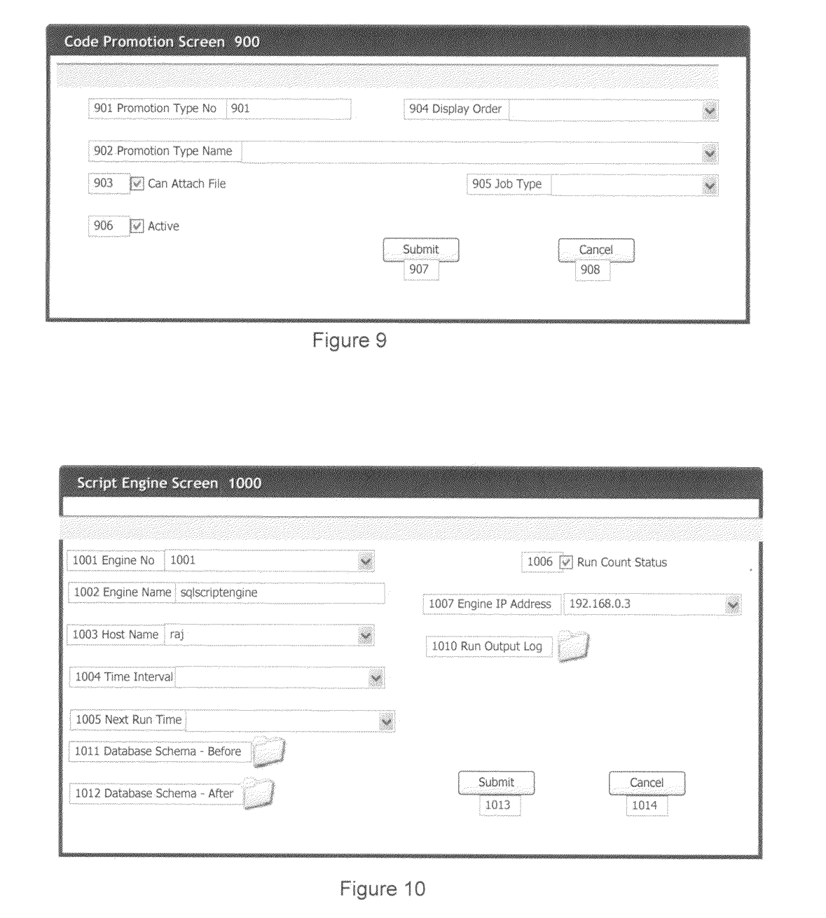

The code promotion screen, FIG. 9, screen 900, is used to define software components to be migrated and moves code for the release while, the migration job status screen 800, is used to schedule migrated jobs to be executed. Screen 800 can be viewed as a sub screen of the migration screen, 600 because most of the data comes from screen 600. In addition, screen 800 also contains code promotion data entered in screen, 900. On screen 800, when the migration request number 803 is selected from the ddw, the target stage, 804 migration request headline 807 and project name 808 are auto populated with corresponding data from screen 600. Similarly, when the job number 801 is selected from the ddw, the job type entered in FIG. 9 screen 900, 902 is auto populated in screen 800, 802. The name of the person who is submitting the task for execution by the script engine is entered in 809. The task number 805 is auto generated when a new migration job status 800 is opened. The job status 806 can be selected from the drop down listbox. Sample data for the job status are, not submitted when the task has not been submitted to the script engine for execution, submitted, when the task has been submitted but not completed, and completed when the script engine has completed the task. The code promotion form as described above is depicted in FIG. 9 screen 900. The promotion type number 901, is auto generated when a new promotion is opened and the type name 902, is the name of the promotion type and signifies, the kind of promotion such as, database, UNIX script or web deployment, etc. Every item to be promoted is assigned a type number and it is used to schedule the job in the migration job status. The job type 905, is used as a binder to the migration job status screen 800. the check boxes 903 and 906 are used to signify whether a file can be attached with the promotion or the promotion is active respectively.

The script engine screen FIG. 10, 1000 is used to run the task that has been scheduled in the migration job status screen, 800. In other for the task to be run successfully, some parameters needs to be defined. When the engine number is selected from the ddw, 1001, the engine name, 1002, engine IP address, 1007 and host name, 1003 are auto-populated. The engine number uniquely defines the type of script that can be executed. For example, the engine name “sqlscriptengine” is the engine to run sql scripts and has the host name of raj and IP address of 192.168.0.3. The time interval, 1004 shows how long the task ran, Next time, 1005 is the next time that the task will run and Run count status, 1006 is a Boolean, yes for task was run and no for not run.

The Run output log, 1010, will be populated with the log from the run and can be accessed by clinking the link on 1010. Database schema before the run, 1011 and after the run, 1012 are also captured and can also be viewed by clinking the link on 1011 and 1012 respectively. The submit button 1013 can be used to run the job in the script engine 1002 or cancel with the Cancel button 1014. Notifications can be defined in Workflow module which are automatically generated and sent to pre-defined set of users and performers based on pre-defined set of events. Properties of input fields can be customized for Change requests and Migration requests.

### CONCLUSION

In the aforementioned disclosure, it can be seen that this invention has sufficiently described a new software change request management system in a, centralized database within a communication network.

What is claimed is:

1. A method of managing a software change request through, the application development life cycle. Initially setting up users basic information, emails, roles, security level, state, stage, action, etc. Creating new default workflow, which defines how the request is routed, by whom and to whom, at each state of the SDLC.

2. Creating a change request ticket and, sending it to the appropriate personnel based on, the stage in the SDLC and derived action by the workflow in claim 1 therein.

3. The method of claim 1 and 2, further comprising: opening a project, associating it with the workflow and change request.

4. The method of claim 3, further comprising assigning the project to a development team member to fix the defect, or work on a new request and subsequently, assigning the project to QA for testing.

5. The method of claim 4, further comprising of moving the tested code to a code release staging directory in production.

6. The method of claim 5, wherein the migrated code is executed by the script engine.

7. The method of claim 6, wherein execution return code, database schema before and after the execution is captured.

8. The method of claim 7, wherein the execution return code as well as all emails notifications and collaborations are shared amongst project team members.

9. The method in claim 1 through 8, wherein the appropriate security level is enforced depending on the project team members, privilege.

10. The method as disclosed in this invention wherein, the change request management system comprises of functionality to perform the following capabilities, change request, workflow, project, collaboration, code movement, project document tracking, code execution, status notification, database schema snapshot capture and, execution return code notification to all project team members.
